(19) United States
(12) Patent Application Publication
(10) Pub. No.: US 2009/0164099 A1
(43) Pub. Date: Jun. 25, 2009

(54) CONTROLLER FOR AN INTERNAL COMBUSTION ENGINE

(75) Inventors: Kunihiko SUZUKI, Hitachinaka (JP); Mamoru Nemoto, Hitachiota (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/337,114

(22) Filed: Dec. 17, 2008

(30) Foreign Application Priority Data
Dec. 21, 2007 (JP) 2007-330276

(51) Int. Cl. F02D 41/30

(52) U.S. Cl. 701/103; 123/90.15

(57) ABSTRACT

The present invention has a means for calculating the amount of air to be inhaled into the cylinder in a steady state of an internal combustion engine by using a regression model based on the rotational speed of an internal combustion engine, the pressure in an intake pipe, and the valve lift characteristics of the variable valve, and also includes a means for estimating the amount of air to be inhaled into the cylinder of an internal combustion engine by compensating for a delay in flow rate detection by an intake airflow rate detection means according to a change in the amount of air to be inhaled that is caused by a change, which is calculated by the regression model, in variable valve operation.

### CLAIM OF PRIORITY

The present application claims priority from Japanese patent application serial No. 2007-330276, filed on Dec. 21, 2007, the content of which is hereby incorporated by reference into this application.

### FIELD OF THE INVENTION

The present invention relates to an internal combustion engine equipped with a variable valve and an intake airflow rate detection means for detecting the airflow rate in an intake pipe.

### BACKGROUND OF THE INVENTION

Recent general internal combustion engines for automobiles tend to have variable valve mechanisms, which make valve timing or valve lifts variable, for the intake valve and exhaust valve. These variable valve mechanisms are improved so that more degrees of freedom are obtained in control, their operation ranges are expanded, and their responses are fastened.

In particular, a variable valve mechanism that can continuously change and control the valve lift has been developed, and a throttle-less internal combustion engine has been developed by which pump loss is reduced and a mirror cycle is achieved by using the intake valve, instead of the throttle valve, to control the amount of air to be inhaled into the cylinder by the variable valve mechanism for continuously changing the lift.

In a controller for an internal combustion engine equipped with this type of variable valve mechanism, an airflow sensor provided in the intake pipe detects the flow rate of inhaled air that passes through the intake pipe, a charging efficiency is calculated from the detected flow rate, and the amount of fuel to be injected and an amount by which the ignition timing is controlled are calculated according to the charging efficiency.

When the variable valve mechanism operates and thereby valve lift characteristics change, the charging efficiency changes. It is known that the charging efficiency immediately starts to change in response to the change in the valve lift characteristics, but the value detected by the airflow sensor disposed in the intake pipe is delayed in being changed due to the presence of a manifold disposed between the cylinder and airflow sensor.

Accordingly, if the charging efficiency is obtained from the value detected by the airflow sensor and a rotational speed, error is generated in the charging efficiency during transition of the variable valve. The error in the charging efficiency reduces accuracy in air-fuel ratio control and ignition timing control, which are performed on the basis of the charging efficiency. As a result, the fuel concentration is made lean or rich during operation of the variable valve, or the ignition timing deviates from an optimum ignition timing, worsening operability and exhaust performance and causing other problems.

To address these problems, Japanese Patent Laid-open No. Hei 11(1999)-264330 discloses a technology for calculating the charging efficiency from the value detected by the airflow sensor even during transition of the variable valve. The calculation is effected by obtaining a difference between a charging efficiency change caused by the operation of the variable valve and a value obtained by applying two-time primary delay processing to the charging efficiency change and adding the difference to a result obtained by applying primary delay processing to an airflow sensor output.

### SUMMARY OF THE INVENTION

However, an engine undergoes an infinite number of transition states. In a method in which charging efficiencies for all combinations of variable valve transitions are stored in an electronic control unit (ECU) as a map, memory with a large capacity needs to be installed in the ECU.

If a plurality of charging efficiency maps obtained by giving variable valve operation levels in a discrete manner are used to perform linear interpolation and obtain the charging efficiency corresponding to an amount by which the variable valve is operated during transition, sufficient accuracy cannot be achieved. The above problems become more serious when degrees of freedom in control are increased or the operation range is expanded.

The present invention addresses the above problems with the object of providing a controller, intended for an internal combustion engine, which can calculate the charging efficiency with high accuracy even during transition of the variable valve.

The present invention has a means for calculating the change in a charging efficiency in a steady state of an internal combustion engine by using a regression model based on the rotational speed of the internal combustion engine, the pressure in an intake pipe, and a change in the state of a variable valve mechanism, and also includes a means for estimating the charging efficiency of the internal combustion engine by compensating for a delay in flow rate detection by an intake airflow rate detection means according to the charging efficiency change calculated by the regression model.

The present invention has a means for calculating the amount of air to be inhaled in a steady state of an internal combustion engine by using a regression model based on the rotational speed of the internal combustion engine, the pressure in an intake pipe, and a change in the state of a variable valve mechanism, and compensates for a delay in flow rate detection by an intake airflow rate detection means according to a charging efficiency change caused by a change in variable valve operation and calculated by the regression model.

The use of the regression model enables the charging efficiency change caused by the change in variable valve operation to be estimated, without a delay.

If only the regression model is used, however, it is difficult to quantitatively calculate the charging efficiency because of variations of individuals in an internal combustion engine, aging, and other effects. When the value detected by the intake airflow rate detection means is used, the problems with the variations of individuals in an internal combustion engine and aging can be solved. Since both the regression model and the intake airflow rate detection means are used, the charging efficiency can be accurately estimated without a delay even during transition of the variable valve.

### BRIEF DESCRIPTION OF THE DRAWINGS

FIG. 1 illustrates the structure of an embodiment of the present invention.

FIG. 2 illustrates valve lift characteristics of an intake valve and an exhaust valve, each of which has a variable valve mechanism that can continuously change and control the valve timing.

FIG. 3 illustrates control blocks for calculating a charging efficiency.

FIG. 4 illustrates control blocks for calculating a charging efficiency by a different method.

FIG. 5 illustrates how outputs from control blocks that calculate the amount of air to be inhaled into a cylinder change with time in an internal combustion engine when a throttle valve, which is used by the internal combustion engine for load control, is changed rapidly from an operation state under a partial load to a fully open state.

FIG. 6 illustrates how outputs from control blocks that calculate the amount of air to be inhaled into the cylinder change with time in an internal combustion engine when the throttle valve, which is used by the internal combustion engine for load control, is nearly fully closed rapidly from the fully open state.

FIG. 7 illustrates how outputs from control blocks change with time, the control blocks calculating the charging efficiency when an overlap period, during which both an intake valve and an exhaust valve are open simultaneously, is prolonged and shortened by controlling a variable valve.

FIG. 8 illustrates a regression model that obtains the charging efficiency in a steady state of an internal combustion engine that uses the throttle valve to perform load control.

FIG. 9 illustrates a regression model that obtains ignition timing.

FIG. 10 illustrates control blocks that calculate the ignition timing and the amount of fuel to be injected.

FIG. 11 illustrates output results of the ignition timing and the amount of fuel to be injected when the overlap period is shortened and prolonged by controlling the variable valve in the control blocks that calculate the ignition timing and the amount of fuel to be injected.

FIG. 12 illustrates a flow for creating a cylinder charging efficiency regression model in a steady state.

FIG. 13 illustrates a process to optimize a polynomial regression model in a likelihood ratio test and calculation of a risk percentage.

FIG. 14 is a graph indicating a relation between approximation accuracy achieved by the regression model and a calculation burden when tolerance of the risk percentage is set to a plurality of levels.

FIG. 15 gives graphs, each of which indicates a relation between the overlap period and the amount of internal EGR at a low altitude or high altitude.

FIG. 16 is a graph indicating relations between the overlap period and the charging efficiency at a high altitude and low altitude.

FIG. 17 illustrates a regression model for obtaining the charging efficiency in the steady state at a high altitude.

FIG. 18 illustrates how outputs from control blocks change with time, the control blocks calculating the charging efficiency when the overlap period is prolonged and shortened by controlling the variable valve at a high altitude.

FIG. 19 illustrates output results of the ignition timing and the amount of fuel to be injected when the overlap period is shortened and prolonged by controlling the variable valve, at a high altitude, in the control blocks that calculate the ignition timing and the amount of fuel to be injected.

FIG. 20 illustrates relations to time constants included in primary elements used in delay elements 1 and 2.

FIG. 21 illustrates the valve lift characteristics of an intake valve equipped with a variable valve mechanism that can continuously change and control the valve timing and valve lift in an internal combustion engine that uses a variable valve for load control.

FIG. 22 illustrates control blocks for calculating the charging efficiency in an engine system in which a throttle valve is not used to reduce the intake airflow rate.

FIG. 23 illustrates control blocks for calculating the amount of air to be inhaled into the cylinder in an engine system that uses a different method in which a throttle valve is not used to reduce the amount of air to be inhaled.

FIG. 24 illustrates a regression model that obtains the charging efficiency in the steady state of an internal combustion engine that uses the variable valve to perform load control.

FIG. 25 illustrates a regression model that obtains ignition timing in an internal combustion engine in which the variable valve is used for load control.

FIG. 26 illustrates how outputs from control blocks change with time, the control blocks calculating the charging efficiency when the actuation angle of the intake valve is increased and decreased by controlling the variable valve.

FIG. 27 illustrates output results of the ignition timing and the amount of fuel to be injected when the actuation angle of the intake valve is increased or decreased by controlling the variable valve, in the control blocks that calculate the ignition timing and the amount of fuel to be injected.

FIG. 28 illustrates a relation to a time constant included in a primary element used in delay element 3.

### DESCRIPTION OF THE PREFERRED EMBODIMENTS

An embodiment of the present invention will be described below with reference to the drawings.

An embodiment of the present invention will be described below with reference to the drawings.

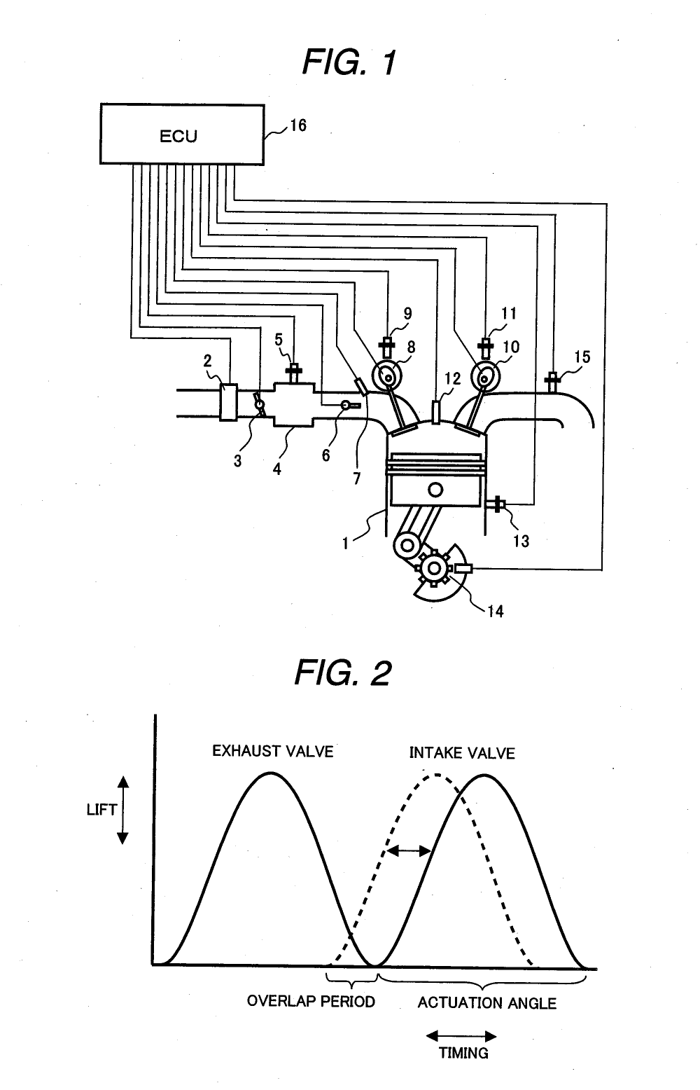

FIG. 1 illustrates the structure in an embodiment of the present invention. The system in the embodiment includes an internal combustion engine 1, with which an intake path and an exhaust path communicate. An airflow sensor and intake temperature sensor 2 are attached to the intake path.

A throttle valve 3 is provided downstream of the airflow sensor 2. The throttle valve 3 is an electronically controlled throttle valve, a throttle opening of which can be controlled independently of the downward travel of the accelerator pedal. An intake manifold 4 communicates downstream of the throttle valve 3. An intake pipe pressure sensor 5 is attached to the intake manifold 4.

A fuel injection valve 7 for injecting fuel into an intake port is provided downstream of the intake manifold 4. The internal combustion engine 1 is equipped with an intake valve 8, which has a variable valve mechanism for making valve timing variable. The variable valve mechanism has a sensor 9 for detecting the valve timing.

The internal combustion engine 1 is also equipped with an exhaust valve 10. The exhaust valve 10 also has a variable valve mechanism for making an exhaust valve-timing variable. A sensor 11 detects opening and closing times of the exhaust valve. An ignition plug 12, an electrode part of which is exposed to the interior of a cylinder, is attached to a cylinder head.

The cylinder also has a knock sensor 13 for detecting a knock. A crank angle detection sensor 14 is attached to a crankshaft. The rotational speed of the internal combustion engine 1 can be determined according to an output signal from the crank angle detection sensor 14. An A/F sensor or O2 sensor 15 is attached to the exhaust path.

The system in this embodiment has an ECU 16 as shown in FIG. 1. The sensors described above are connected to the ECU 16. The throttle valve 3, the fuel injection valve 7, the intake valve 8 with a variable valve mechanism, the exhaust valve 10 with a variable valve mechanism, and other actuators are controlled by the ECU 16.

The operation state of the internal combustion engine 1 is detected according to signals input from the sensors described above, and the ignition plug 12 performs ignition at a timing determined by the ECU 16 according to the operation state.

FIG. 2 illustrates valve lift characteristics of the intake valve and the exhaust valve, each of which has a variable valve mechanism that can continuously change and control the valve timing. As shown in the drawing, when a timing at which the intake valve opens is controlled to change the length of an overlap period, during which both the intake valve and the exhaust valve are open simultaneously, the amount of burned gas remaining in the cylinder (internal exhaust gas recirculation (EGR)) is controlled.

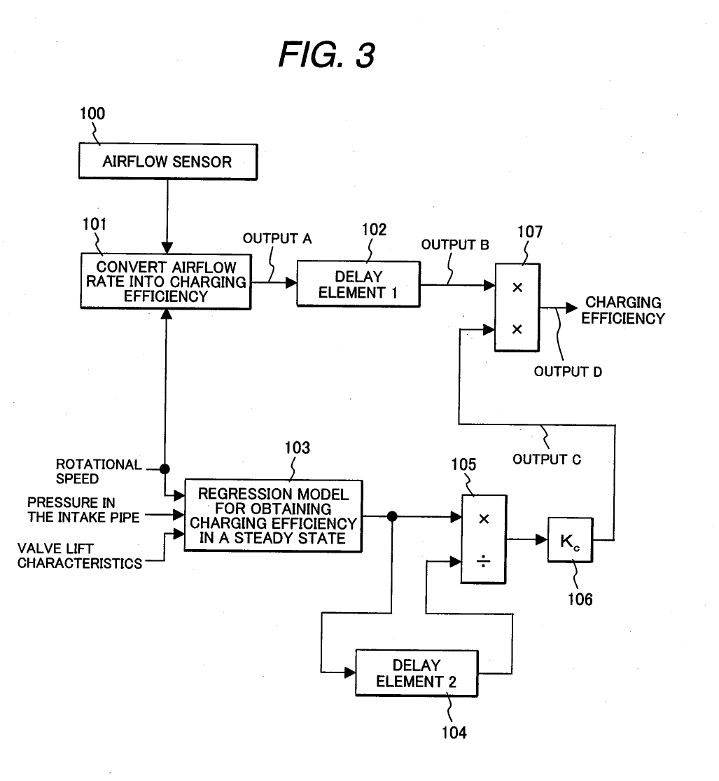

FIG. 3 illustrates control blocks for calculating a charging efficiency. The block 100 detects an output value from the airflow sensor and a rotational speed, according to which the block 101 converts the flow rate detected by the airflow sensor to a charging efficiency. In the block 102, delay element 1 performs processing.

Delay element 1 is represented by a primary delay transmission function in which a time constant is denoted τand a gain is assumed to be 1.0. In the block 103, a regression model calculates the charging efficiency in the steady state by using the rotational speed, intake pipe pressure, and valve lift characteristics as input variables. The calculated charging efficiency is used to calculate a change in the charging efficiency in the steady state, and the calculation result is output, the change in the charging efficiency being caused when the valve lift characteristics change during variable valve control.

In the block 104, the change in the charging efficiency in the steady state during variable valve control, which has been calculated above, undergoes processing by delay element 2. In the block 105, a ratio between the above charging efficiency change and a value obtained after the above delay processing has been performed is obtained. Delay element 2 is represented by a primary delay transmission function in which a time constant is denoted τ₂ and a gain is assumed to be 1.0.

In the block 106, the above ratio is multiplied by a gain constant K_{c}. The charging efficiency is calculated from a product of the output value from the block 102 and the output value from the block 106. The above time constant τ₁, time constant τ₂, and gain constant K_{c} are matching constants. They are matched to optimum values in advance so that any transient behavior, described later, is accurately predicted.

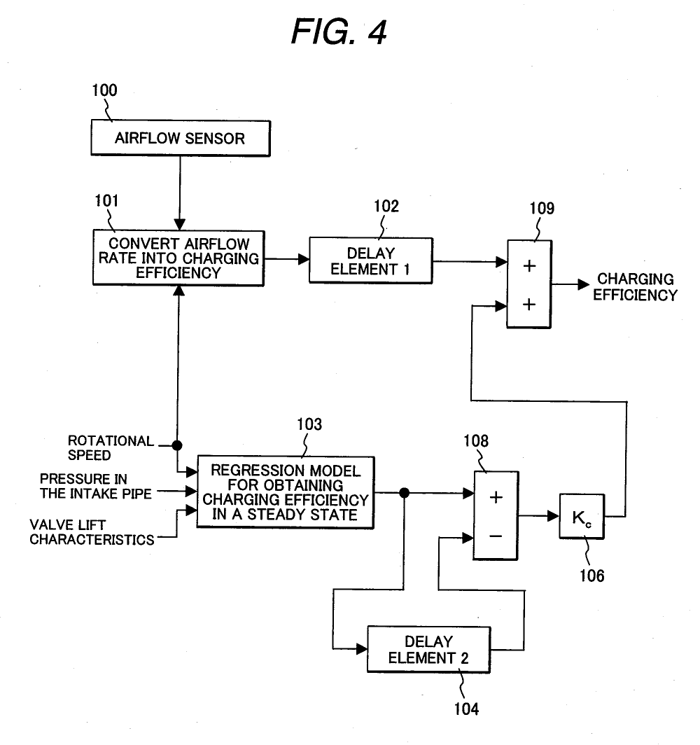

As described above, the single control logic shown in FIG. 3 can accurately calculate the charging efficiency even when both a rapid throttle valve change and a rapid variable valve change occur. However, the present invention is not limited to the above control logic; control blocks shown in FIG. 4 can also provide the same effect as the method in FIG. 3.

A part in which the regression model calculates the charging efficiency in the steady state by using the rotational speed, intake pipe pressure, and valve lift characteristics as input variables is referred to as a means for calculating a charging efficiency change in the steady state of an internal combustion engine.

The control blocks illustrated in FIG. 4 calculate the charging efficiency by a different method. In the method in FIG. 4, delay processing is applied to the output value from the airflow sensor, and a difference between a charging efficiency change, in the steady state, which is caused by a change in the valve lift characteristics during variable valve control and a value obtained by applying delay processing to the charging efficiency change is added to the delay processing result of the airflow sensor output value.

In this method as well, transient behavior of the charging efficiency can also be calculated with high accuracy.

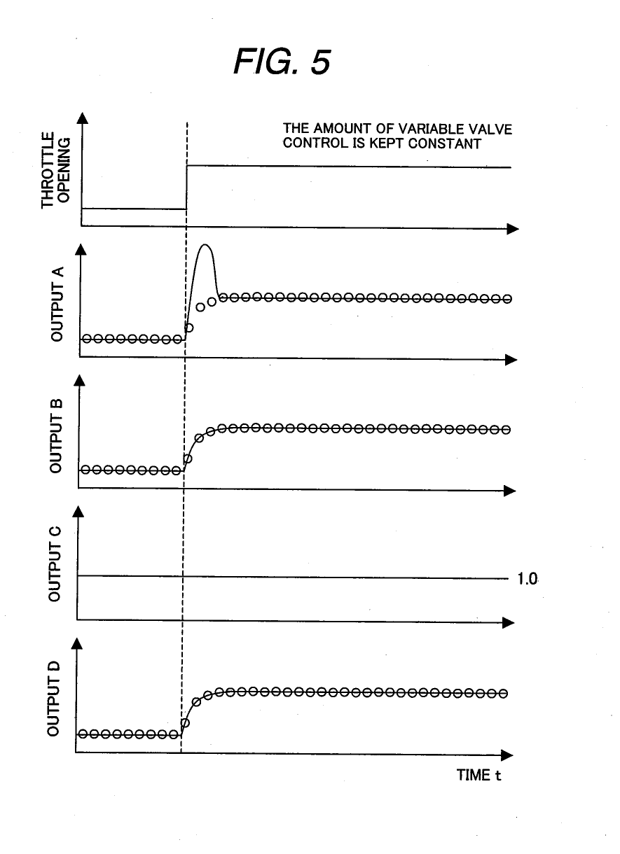

In an internal combustion engine in which a throttle valve is used for load control, the throttle valve may be changed rapidly from an operation state under a partial load to a fully open state. FIG. 5 illustrates how outputs from control blocks that calculate the amount of air to be inhaled into the cylinder change over time when the above change occurs.

The amount of variable valve control is kept constant. When the throttle valve is closed, the pressure in the manifold disposed downstream of the throttle valve is negative. Accordingly, when the throttle valve is fully opened rapidly, a difference in pressure occurs and thereby air immediately enters the manifold.

The output value from the airflow sensor disposed upstream of the throttle valve largely overshoots and then converges to a steady state, as in the case of output A. The amount of air actually inhaled into the cylinder is plotted with white circles (◯) in the drawing. As shown in the drawing, unlike the case of the airflow sensor output value, there is no overshoot in the amount of air actually inhaled into the cylinder.

As described above, it is known that there is a delay between the output value of the airflow sensor and the amount of air actually inhaled into the cylinder. Accordingly, delay element 1 performs delay processing to have output B accurately approximate to the amount of air actually inhaled into the cylinder.

At that time, since the amount of variable valve control is kept constant, there is no change in the charging efficiency in the steady state during variable valve control, indicating a reference value, which is 1.0. Accordingly, output B before the block 107 becomes equal to output D after the block 7.

After the processing described above has been performed, the charging efficiency is accurately calculated by using the value detected by the airflow sensor as the input.

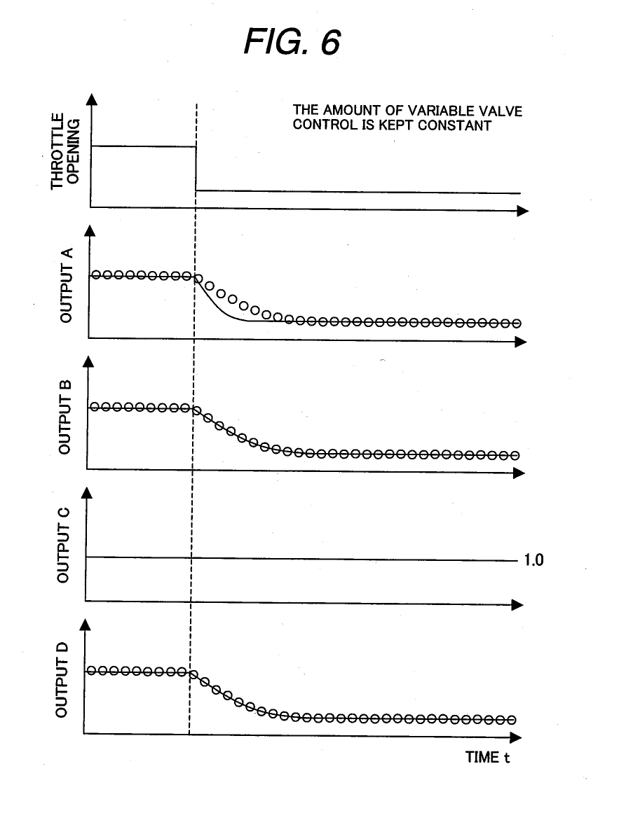

In an internal combustion engine in which a throttle valve is used for load control, the throttle valve may be nearly fully closed rapidly from the fully open state. FIG. 6 illustrates how outputs from control blocks that calculate the amount of air to be inhaled into the cylinder change with time when the above change occurs.

The amount of variable valve control is kept constant. When the throttle valve is closed rapidly, the flow rate in the airflow sensor disposed upstream of the throttle valve decreases relatively immediately. It is known that the amount of air actually inhaled into the cylinder involves a delay when compared with the flow rate in the airflow sensor.

In these control blocks that calculate the charging efficiency, delay element 1 is used to apply delay processing, so the above delay can be accurately approximated. Since the amount of variable valve control is kept constant, there is no change in the charging efficiency in the steady state during variable valve control. Accordingly, output B before the block 107 becomes equal to output D after the block 7.

After the processing described above has been performed, the charging efficiency is accurately calculated by using the value detected by the airflow sensor as the input.

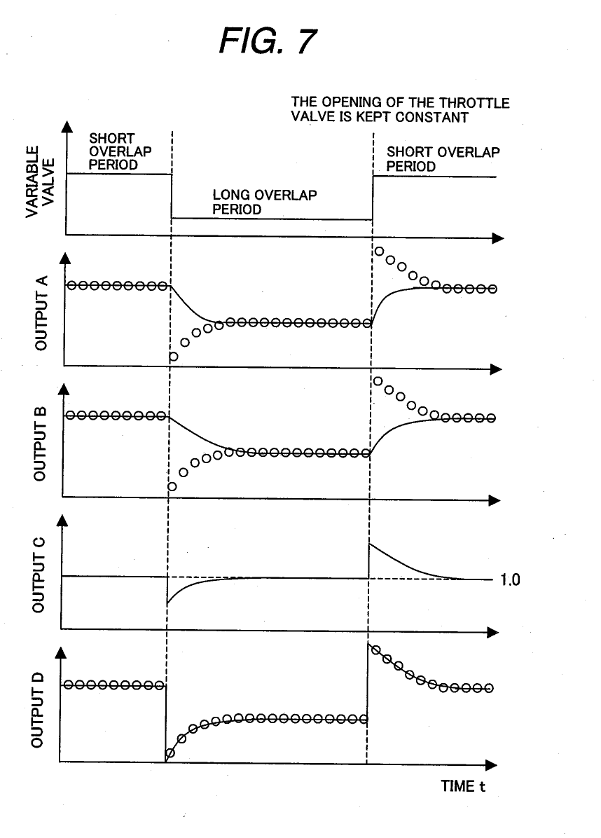

FIG. 7 illustrates how outputs from control blocks change with time, the control blocks calculating the charging efficiency when the overlap period, during which both the intake valve and the exhaust valve are open simultaneously, is prolonged and shortened by controlling a variable valve.

While the outputs from the control blocks change with time, the opening of the throttle valve is kept constant under a partial load. When the overlap period is prolonged like a rectangular waveform, the output value of the airflow sensor gradually decreases. The amount of air actually inhaled into the cylinder decreases with an overshoot, after which it converges to a steady state.

As described above, when the state of the variable valve changes rapidly, the output value of the airflow sensor involves a delay with respect to the amount of air actually inhaled into the cylinder. This delay also occurs even when the overlap period is shortened like a rectangular waveform.

Delay processing by the block 102 is applied to the airflow sensor output value involving the delay.

Output C is obtained as a ratio between a charging efficiency change, in the steady state, that is caused by a change in the valve lift characteristics during variable valve control and a value obtained by applying delay processing to the change. When output B, which is used as a compensation value, is multiplied by the ratio in the block 107, the amount of air actually inhaled into the cylinder is calculated.

After the processing described above has been performed, the charging efficiency is accurately calculated by using the value detected by the airflow sensor as the input even when the state of the variable valve changes rapidly.

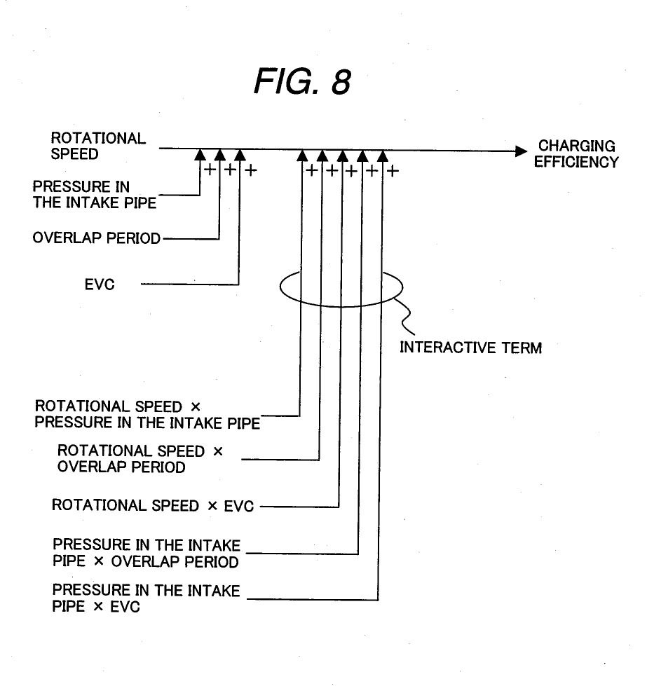

FIG. 8 illustrates a regression model that obtains the charging efficiency in a steady state of an internal combustion engine that uses a throttle valve to perform load control.

In this embodiment, a polynomial regression model that considers the rotational speed, the pressure in the intake pipe, the overlap period, and the effect of the EVC, which are given to the charging efficiency, is used to calculate the charging efficiency in the steady state. Terms up to a quartic term are considered by using these effect factors as explanatory variables.

To represent effects by interactive action among the above effect factors in a model, interactive terms are provided up to the quartic term.

When high-order terms and interactive terms are included in the regression model in this way, the engine charging efficiency, which is non-linear, can be efficiently approximated.

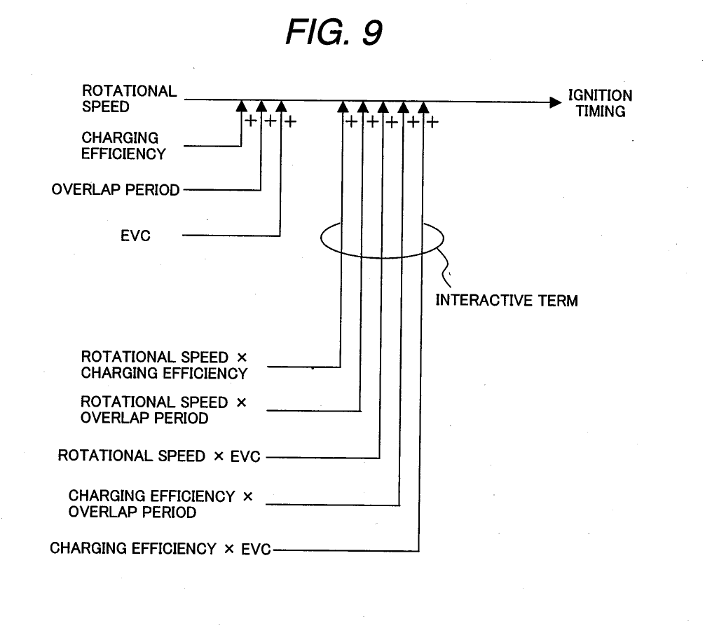

FIG. 9 illustrates a regression model that obtains ignition timing.

To accurately obtain the ignition timing, at least the rotational speed, charging efficiency, overlap period, and EVC are used as input variables supplied to the regression model. High-order terms and interactive terms are set for the variables so that the regression model is optimized by likelihood ratio test, as described below, as in the charging efficiency regression model.

The reason why the overlap period and EVC are used as variables is that they are important factors that determine the internal EGR, which is considered to have a large effect on the ignition timing. The atmospheric pressure (not indicated in the regression model) can also be added as a variable.

When the effect of the atmospheric pressure is considered, using the regression model can accurately approximate an effect of the ignition timing, which changes due to a reduction in the internal EGR at a high altitude.

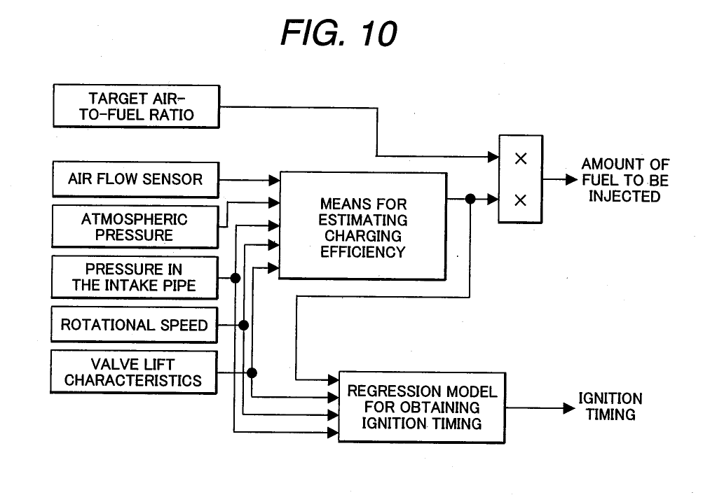

FIG. 10 illustrates control blocks that calculate the ignition timing and the amount of fuel to be injected.

A value from the airflow sensor, the atmospheric pressure, the pressure in the intake pipe, the rotational speed, and the valve lift characteristics are input into a charging efficiency estimation means with the effect of variable valve control and a high altitude taken into consideration. The charging efficiency estimation means has the control means as described with reference to in FIG. 3 or 4.

The amount of fuel to be injected is calculated from the amount of air filled into the cylinder, which has been obtained by the above charging efficiency estimation means, and a target air-fuel ratio. The ignition timing is obtained by the regression model, in which the charging efficiency is used as an input variable.

The output value (flow rate) of an intake airflow rate detection means, which is the airflow sensor, involves a delay with respect to the amount of air actually inhaled into the cylinder. However, to accurately estimate the charging efficiency of an internal combustion engine, the delay is compensated according to the charging efficiency change calculated by the regression model described above. The means for performing the estimation is referred to as the means for correcting the delay in flow rate detection by the intake air detection means, according to the charging efficiency change calculated by the regression model, and estimating the charging efficiency of the internal combustion engine.

The means for calculating the amount of fuel to be injected according to the charging efficiency of an internal combustion engine and the target air-fuel ratio includes the calculation of the amount of fuel to be injected according to the amount of air filled into the cylinder and the target air-fuel ratio.

Means for estimating the charging efficiency of an internal combustion engine will be listed below.

1. Means for estimating the charging efficiency of an internal combustion engine by applying processing by a delay element to the charging efficiency change calculated by a regression model, obtaining a delay compensation amount from a ratio between the charging efficiency change before the processing and another charging efficiency change after the processing, and multiplying the flow rate detected by the intake airflow rate detection means by the delay compensation amount.

2. Means for estimating the charging efficiency of an internal combustion engine by applying processing by a delay element to the charging efficiency change calculated by a regression model, obtaining a delay compensation amount from a ratio between the charging efficiency change before the processing and another charging efficiency change after the processing, and adding the delay compensation amount to the flow rate detected by the intake airflow rate detection means.

3. Means for estimating the charging efficiency of an internal combustion engine by applying processing by a delay element to the charging efficiency change calculated change by a regression model, obtaining a delay compensation amount from a ratio between the charging efficiency change before the processing and another charging efficiency change after the processing, applying processing by another delay element to the flow rate detected by the intake airflow rate detection means, and multiplying the flow rate to which the processing by the other delay element has been applied by the delay compensation amount.

4. Means for estimating the charging efficiency of an internal combustion engine by applying processing by a delay element to the charging efficiency change calculated by a regression model, obtaining a delay compensation amount from a difference between the charging efficiency change before the processing and another charging efficiency change after the processing, applying processing by another delay element to the flow rate detected by the intake airflow rate detection means, and adding the delay compensation amount to the flow rate to which the processing by the other delay element has been applied.

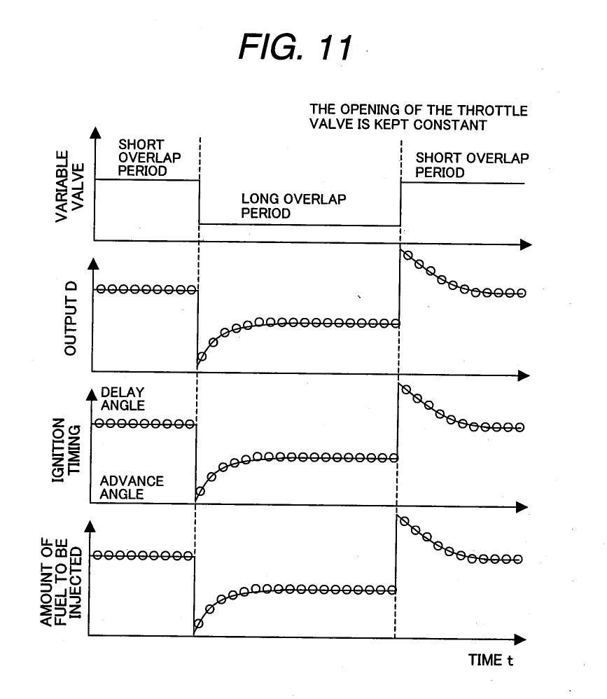

FIG. 11 illustrates output results of the ignition timing and the amount of fuel to be injected when the overlap period is shortened and prolonged by controlling the variable valve in the control blocks that calculate the ignition timing and the amount of fuel to be injected.

The ignition timing and the amount of fuel to be injected are calculated on the basis of the charging efficiency, so they change according to the change in cylinder charging efficiency during transition. When the overlap period is prolonged rapidly, the cylinder charging efficiency decreases with an overshoot, after which it converges to a steady state. At that time, the internal EGR increases with an overshoot, after which it converges to a steady state.

The ignition timing is controlled at an advanced angle to cause an overshoot according to the charging efficiency change and internal EGR change described above, after which it converges to a steady state. The amount of fuel to be injected also changes according to the overshoot of the charging efficiency. In case of a rapid decrease in the overlap period as well, the ignition timing and the amount of fuel to be injected similarly change according to the overshoot of the charging efficiency.

As described above, even during transition of the variable valve, the ignition timing and the amount of fuel to be injected are appropriately calculated or controlled according to the output value of the airflow sensor, preventing the operation performance and exhaust performance from being worsened during transition.

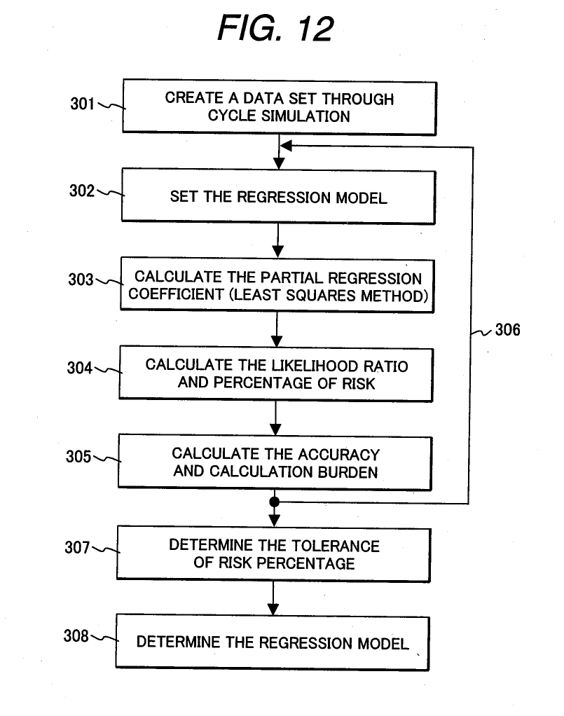

FIG. 12 illustrates a flow for creating a cylinder charging efficiency regression model in a steady state.

In step 301, a plurality of levels are set by using the rotational speed, the pressure in the intake pipe, the overlap period, and EVC as parameters, and a charging efficiency based on a combination of these parameters is obtained through cycle simulation.

The cycle simulation comprises a plurality of physical models. Experience constants included in these physical models are tuned according to data measured in advance at typical points on an engine mounted to an actual car. After this tuning has been performed and sufficient prediction accuracy has been confirmed, a data set for the charging efficiency is created.

In step 302, a regression model is created that obtains the charging efficiency in a steady state through regression analysis based on a multi-factor higher-order polynomial, assuming that the data set is data to be analyzed. In step 303, a partial regression coefficient by which terms in the polynomial are multiplied to create a best approximation to the data set is calculated. In the calculation of the partial regression coefficient, the least squares method is used.

In step 304, a likelihood ratio and a percentage of risk for each term in the polynomial are obtained. Setting a target regression model and obtaining a residual between the data to be analyzed and the regression model can obtain the likelihood ratio.

One item is then removed from the regression model and a residual is obtained. A likelihood ratio is obtained according to the residual. The percentage of risk can be obtained from a relation between the likelihood ratio and a chi-square distribution. The percentage of risk is a probability of including, in the regression model, terms that do not contribute to improvement in the accuracy of the approximation of the excluded term in the data to be analyzed.

In step 305, approximation accuracy of the set regression model and a calculation load are obtained. Determination coefficients for which the number of degrees of freedom has been determined, Akaike's information criteria (AIC), etc. can be used as indexes for approximation accuracy. The calculation of the above percentage of risk is repeated for all terms (step 306). In step 307, a risk percentage tolerance is set.

That is, when only terms indicating a value not exceeding the above risk percentage tolerance are included in the model, a regression model comprising only terms with a low percentage of risk can be created (step 308).

Although, in this embodiment, a method based on the likelihood ratio test is used to determine whether to select the items in the regression model, the present invention is not limited to this method. F-test, t-test, and other tests can also be used to appropriately delete unnecessary terms from the regression model and provide the same effect.

To determine the likelihood ratio, only one term has been deleted. However, it is also possible to add one item to obtain the likelihood ratio and determine the risk percentage of the term.

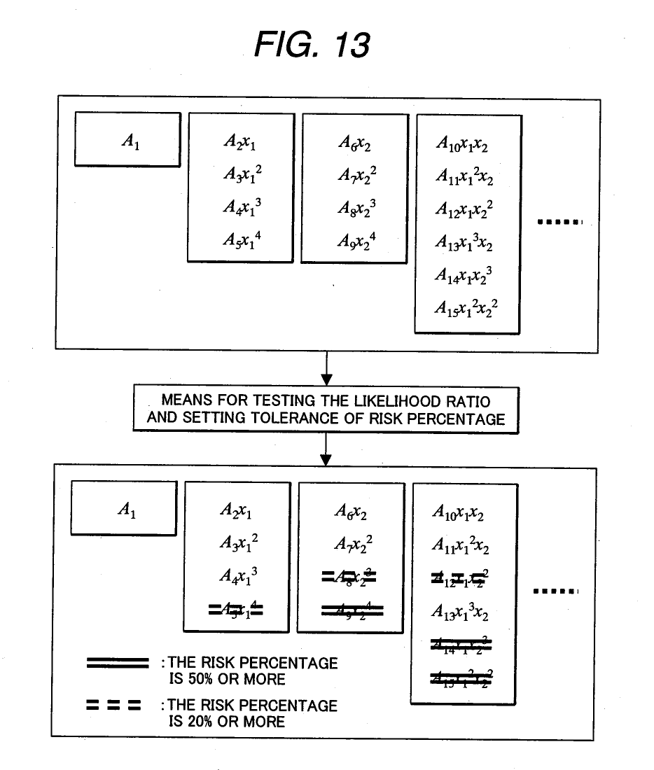

FIG. 13 illustrates a process to optimize the polynomial regression model in the likelihood ratio test and the calculation of the risk percentage.

As shown in the drawing, the number of variables and the number of orders are set, and all terms that can be considered in the combinations of these variables and orders are set in the regression model. Each term is multiplied by the partial regression coefficient.

All of the high-order terms and interactive terms, which have been set as described above, are not always necessary for approximation of the data to be analyzed. Accordingly, the risk percentage of each term is obtained through the likelihood ratio test and a tolerance of the risk percentage is set to determine whether to select the term.

In the lower portion of FIG. 13, the terms indicated by solid double lines are deleted when the tolerance of the risk percentage is 50%, and the terms indicated by broken double lines are deleted when the tolerance is reduced to 20%. As seen from the drawing, terms having relatively high-risk percentages are likely to appear in high-order terms and interactive terms. If these terms are appropriately deleted, the calculation burden can be significantly reduced. As the risk percentage is reduced, more terms are deleted.

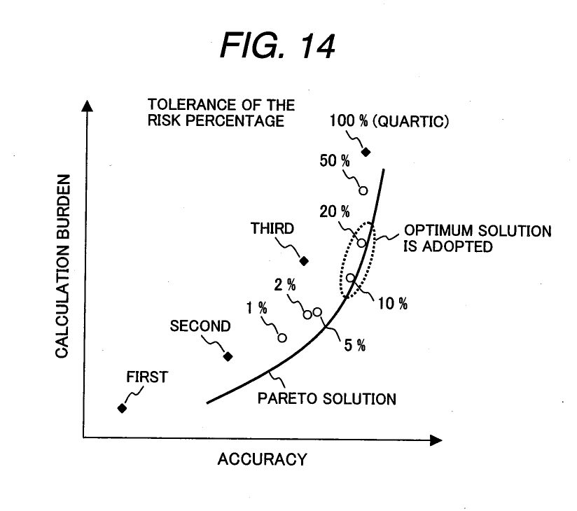

FIG. 14 is a graph indicating a relation between approximation accuracy achieved by the regression model and the calculation burden when the tolerance of the risk percentage is set to a plurality of levels.

The tolerance of the risk percentage was set to 100%, 50%, 20%, 10%, 5%, 2%, and 1%. A regression model was set by using terms selected according to these risk percentages to obtain a relation between accuracy and calculation burden.

Incidentally, when the tolerance of the risk percentage is set to 100%, all terms are selected. In the drawing, a four-order polynomial is set. For comparison purposes, a three-order polynomial, two-order polynomial, and one-order polynomial are plotted with black rhombuses (♦).

When the tolerance of the risk percentage is reduced from 100% to 20%, the accuracy is hardly lowered. In the four-order polynomial, many high-order terms and interactive terms, which do not contribute to improvement in accuracy, are included. When the tolerance of the risk percentage is further reduced, the approximation accuracy is gradually lowered as the calculation burden decreases.

As described above, there is a tradeoff between the approximation accuracy and the calculation burden, so an optimum combination of these two parameters needs to be selected to set an optimum regression model. The drawing shows a Pareto solution for both the approximation accuracy and the calculation burden. An optimum regression model can be selected by selecting a combination on the Pareto solution.

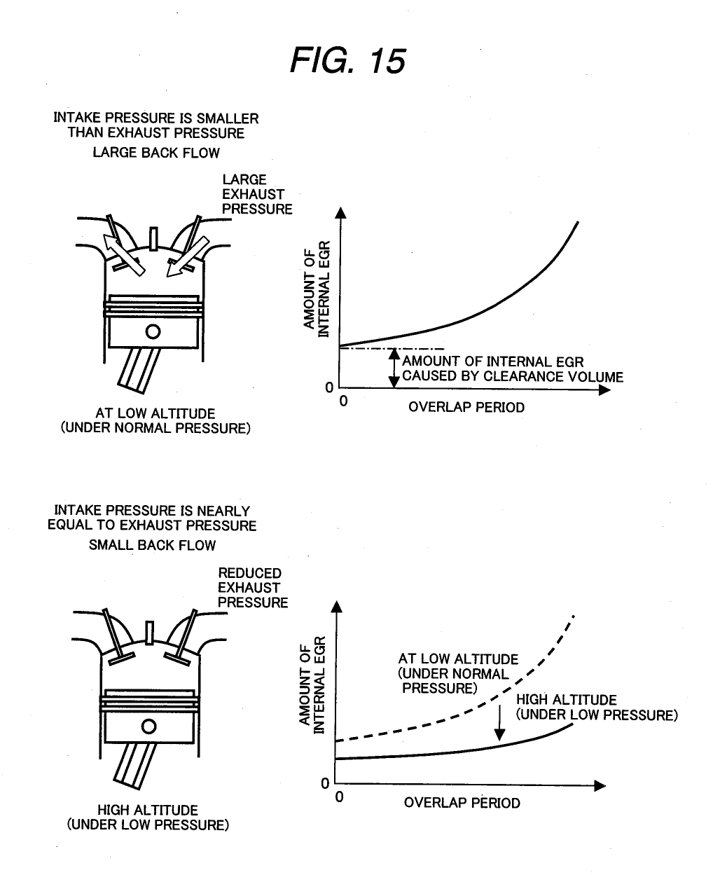

FIG. 15 gives graphs, each of which indicates a relation between the overlap period and the amount of internal EGR at a low altitude or high altitude.

At the low altitude, the pressure in the exhaust valve is higher than the pressure in the intake pipe under a partial load. Accordingly, in the overlap period, during which both the intake valve and exhaust valve are open simultaneously, back flow occurs through the cylinder, causing the amount of internal EGR to increase as the overlap period is prolonged. When the load and rotational speed are the same at the low altitude and high altitude, the exhaust pressure at the high altitude is lower than that at the lower altitude.

At a high altitude, therefore, when the pressure in the intake pipe is the same as that at a low altitude, the difference between the pressure in the intake pipe and the pressure in the exhaust pipe is smaller than that at a low altitude, so the amount of internal EGR decreases. The amount of internal EGR is less likely to increase with the extension of the overlap period as the altitude increases.

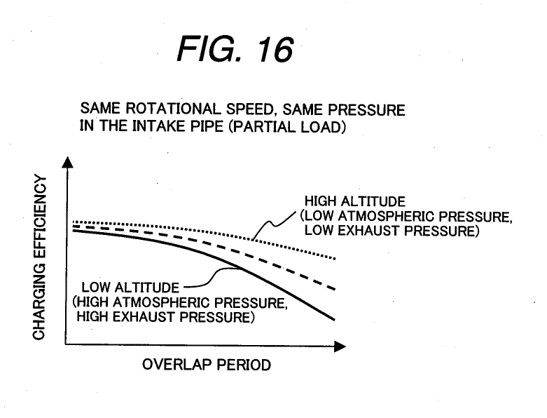

FIG. 16 is a graph indicating relations between the overlap period and the charging efficiency at a high altitude and low altitude.

When the rotational speed and the pressure in the intake pipe are the same at a low altitude and high altitude, the amount of internal EGR is less likely to increase with the extension of the overlap period as the altitude increases, as described above, so the charging efficiency is also less likely to decrease.

Accordingly, to obtain the charging efficiency with high accuracy by using the polynomial regression model, not only the effect of the pressure in the intake pipe but also the effect of the atmospheric pressure or exhaust gas pressure must be considered.

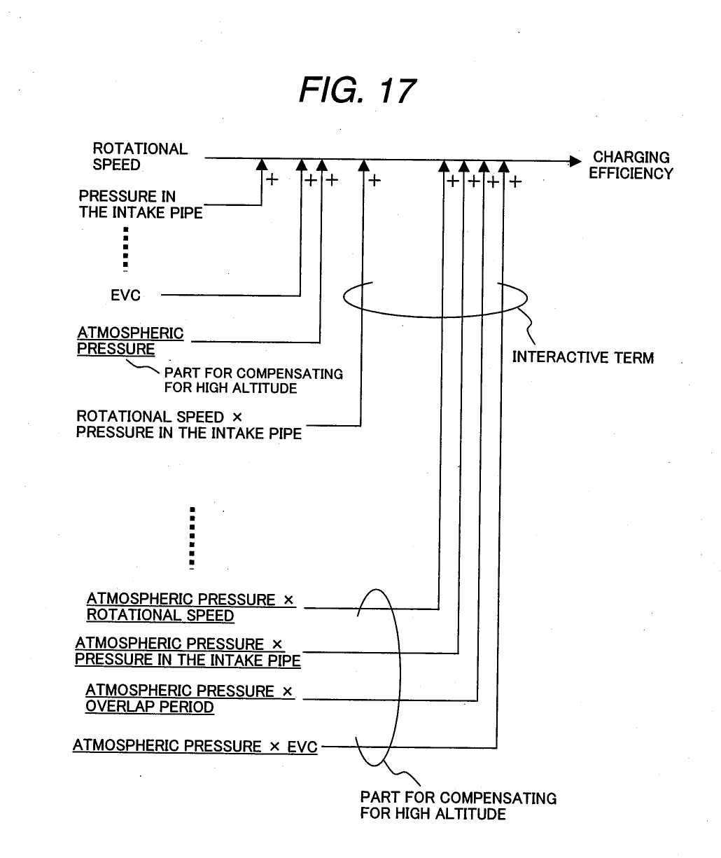

FIG. 17 illustrates a regression model for obtaining the charging efficiency in the steady state at a high altitude.

As indicated by the drawing, since consideration of a high-altitude condition is added, an atmospheric term and an interactive term including an atmospheric variable are further added to the charging efficiency regression model shown in FIG. 8. As described with reference to FIG. 16, the charging efficiency needs consideration of the effect of both the overlap period and the atmospheric pressure or the pressure in the exhaust pipe. This effect can be represented by an interactive term for the atmospheric pressure and overlap period.

As with the above regression model, a decision about which terms to select can be made through the likelihood ratio test to optimize the regression model. The system in this embodiment is not provided with an atmospheric pressure sensor for measuring the atmospheric pressure.

To estimate the atmospheric pressure, the pressure in the intake pipe with the throttle vale being fully open can be regarded as the atmospheric pressure. The pressure in the intake pipe when a negative pressure is not developed in the intake pipe at, for example, a start time may also be regarded as the atmospheric pressure.

A part that performs the above pressure estimation is referred to as a means for detecting or estimating the atmospheric pressure or the pressure in the exhaust pipe.

A part related to the interactive term for the atmospheric pressure and the overlap period is referred to as a means for correcting the charging efficiency by using the interactive term for the overlap period and the difference between the atmospheric pressure or the pressure in the exhaust pipe and the pressure in the intake pipe, the difference being used as a variable.

The embodiment of the present invention is not limited to the above configuration. The atmospheric pressure sensor may be separately disposed upstream of the throttle valve. Alternatively, in a configuration in which an exhaust pipe pressure sensor is provided in the exhaust pipe, a regression model that uses the above exhaust pipe pressure as a parameter may calculate the charging efficiency in a steady state.

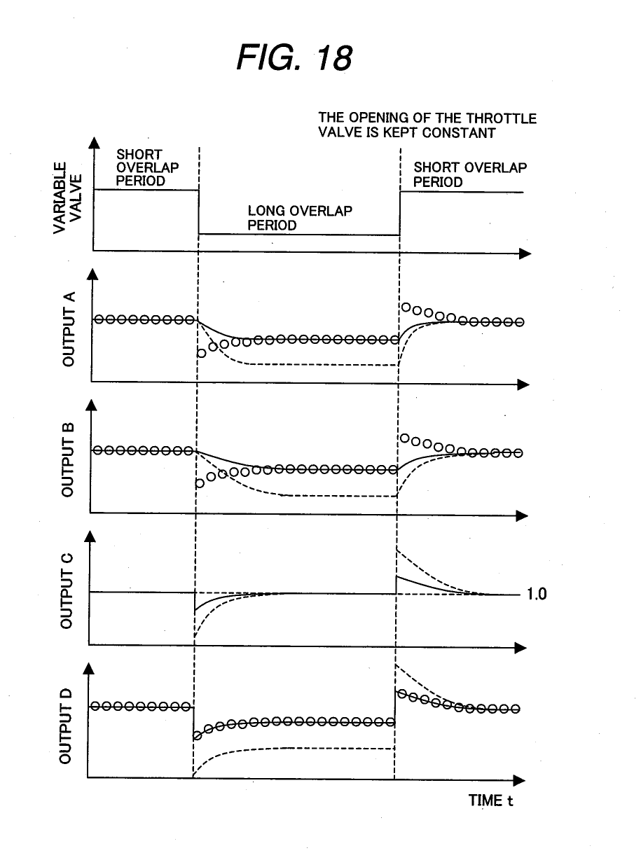

FIG. 18 illustrates how outputs from control blocks change with time, the control blocks calculating the charging efficiency when the overlap period is prolonged and shortened by controlling the variable valve at a high altitude.

While the outputs from control blocks change with time, the opening of the throttle valve is kept constant under a partial load. For comparison purposes, changes of the outputs with time at a low altitude are also shown. When the overlap period is prolonged like a rectangular waveform, the output value of the airflow sensor gradually decreases. The amount of air actually inhaled into the cylinder decreases with an overshoot, after which it converges to a steady state.

As described above, when the state of the variable valve changes rapidly, the output value of the airflow sensor involves a delay with respect to the amount of air actually inhaled into the cylinder. This type of delay also occurs even when the overlap period is shortened like a rectangular waveform. These delays, which are stable behaviors, are almost the same as those at a low altitude. When the overlap period is prolonged, however, reduction in the charging efficiency is smaller than that at a low altitude.

When the term for the atmospheric pressure is added to the regression model on the assumption that the altitude is high, the charging efficiency is accurately calculated even at the high altitude.

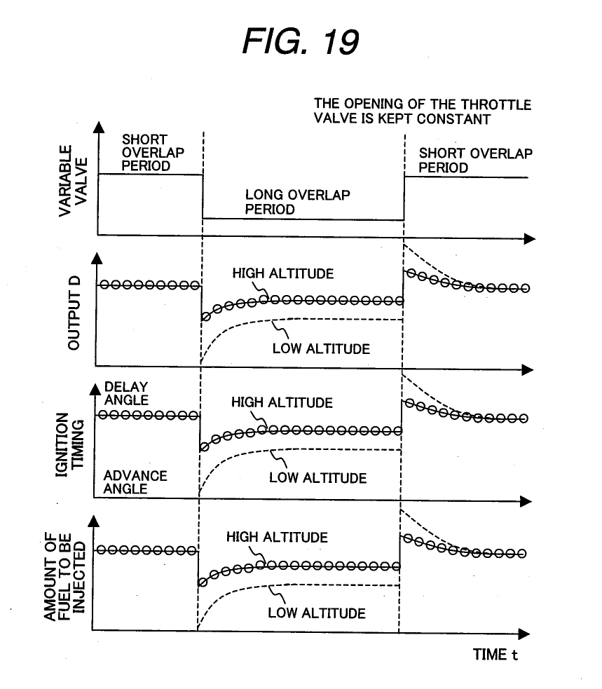

FIG. 19 illustrates output results of the ignition timing and the amount of fuel to be injected when the overlap period is shortened and prolonged by controlling a variable valve, at a high altitude, in control blocks that calculate the ignition timing and the amount of fuel to be injected.

When the overlap period is prolonged rapidly, the cylinder charging efficiency decreases with an overshoot, after which it converges to a steady state. At that time, the internal EGR increases with an overshoot, after which it converges to a steady state. The ignition timing is controlled at an advanced angle to cause an overshoot according to the charging efficiency and internal EGR change described above, after which it converges to a steady state.

The amount of fuel to be injected also changes according to the overshoot of the charging efficiency. In case of a rapid decrease in the overlap period as well, the ignition timing and the amount of fuel to be injected similarly change according to the overshoot of the charging efficiency.

These stable behaviors are almost the same as those at a low altitude. When the overlap period is prolonged, however, reduction in the charging efficiency is smaller than that at a low altitude. Even when the state of the variable valve is changed rapidly at a high altitude as described above, the ignition timing and the amount of fuel to be injected are appropriately calculated or controlled, preventing the operation performance and exhaust performance from becoming worse.

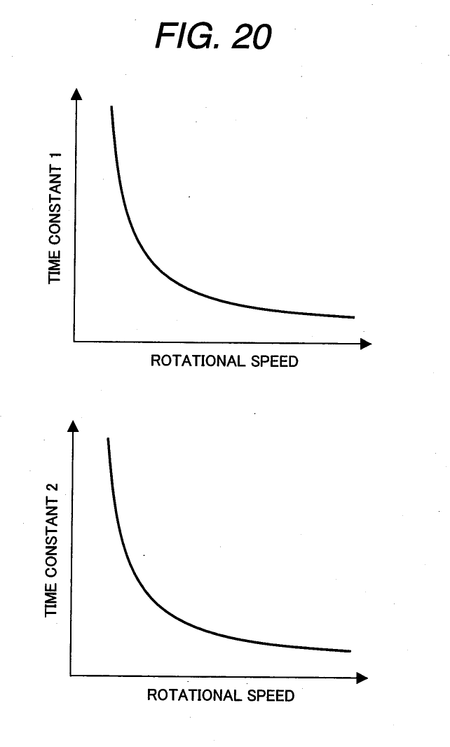

FIG. 20 illustrates relations to time constants included in a primary element used in delay elements 1 and 2.

In comparison under the same engine specifications, the time constants in delay elements 1 and 2 are inversely proportional to the rotational speed; as the rotational speed increases, the time constants decrease.

When the time constants are changed in this way, the amount of air actually inhaled into the cylinder can be accurately calculated by using the single logic shown in FIG. 3 or 4 in response to rapid state changes in both the throttle valve and the variable valve, regardless of whether the rotational speed is high or low.

When these relations between the time constants and the rotational speed are used, the need to adapt the time constants for each rotational speed is eliminated, reducing an adaptation cost.

However, the present invention is not limited to the calculation in which the time constants are obtained only on the basis of the rotational speed. The same effect is obtained by changing the time constants in response to the flow rate of the inhaled air.

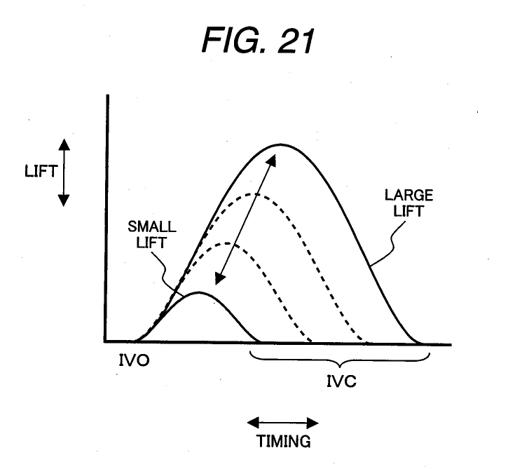

FIG. 21 illustrates the valve lift characteristics of an intake valve equipped with a variable valve mechanism that can continuously change and control the valve timing and valve lift in an internal combustion engine that uses the variable valve for load control.

To control the amount of air to be inhaled into the cylinder, the intake valve is opened at almost the same time and closed at different times and the valve lift is changed, as shown in the drawing. With the variable valve mechanism, in this system, which continuously changes the valve lift, the valve lift and the angle by which the valve is operated are uniquely determined. Accordingly, to open the intake valve at almost the same time, the valve is usually used together with a variable valve timing mechanism.

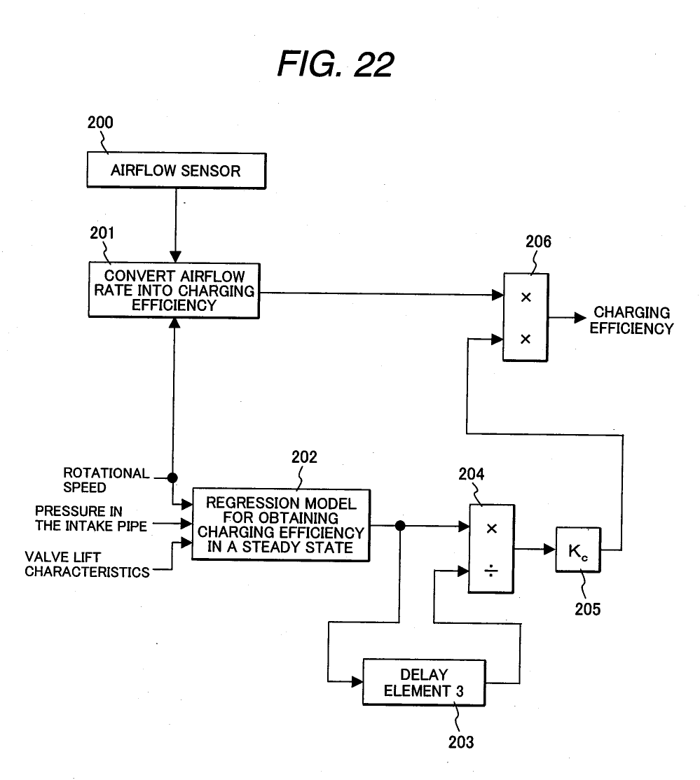

FIG. 22 illustrates control blocks for calculating the charging efficiency in an engine system in which a throttle valve is not used to reduce the intake airflow rate.

In an engine system that does not use a throttle valve to reduce the intake airflow rate, there is no area, in the intake pipe, in which a significant difference in pressure occurs, so a delay, as seen in case of a rapid state change of the throttle valve, does not occur.

Accordingly, in FIG. 22, delay element 1 is removed from the control logic shown in FIG. 3.

The block 201 converts the flow rate in the airflow sensor to a charging efficiency according to the rotational speed and the airflow sensor output value detected in the block 200.

The block 202 uses the rotational speed, the pressure in the intake pipe, and the valve lift characteristics as input variables to calculate the charging efficiency in a steady state by means of a regression model. A change in the charging efficiency in the steady state, which is caused due to a change in the valve lift characteristics in variable valve control, is calculated from the calculated charging efficiency in the steady state, and the calculation result is output.

In the block 203, the change in the charging efficiency in the steady state during variable valve control, which has been calculated above, undergoes processing by delay element 3. In the block 204, a ratio between the above charging efficiency change and a value obtained after the above delay processing has been performed is obtained.

Delay element 3 is represented by a primary delay transmission function in which a time constant is denoted τ₃ and a gain is assumed to be 1.0. In the block 205, the above ratio is multiplied by gain constant K_{c}. The charging efficiency is calculated from a product of the output value from the block 201 and the output value from the block 205.

The above time constant τ₃ and gain constant K_{c} are matching constants. They are matched to optimum values in advance so that a transient behavior, described later, is accurately predicted.

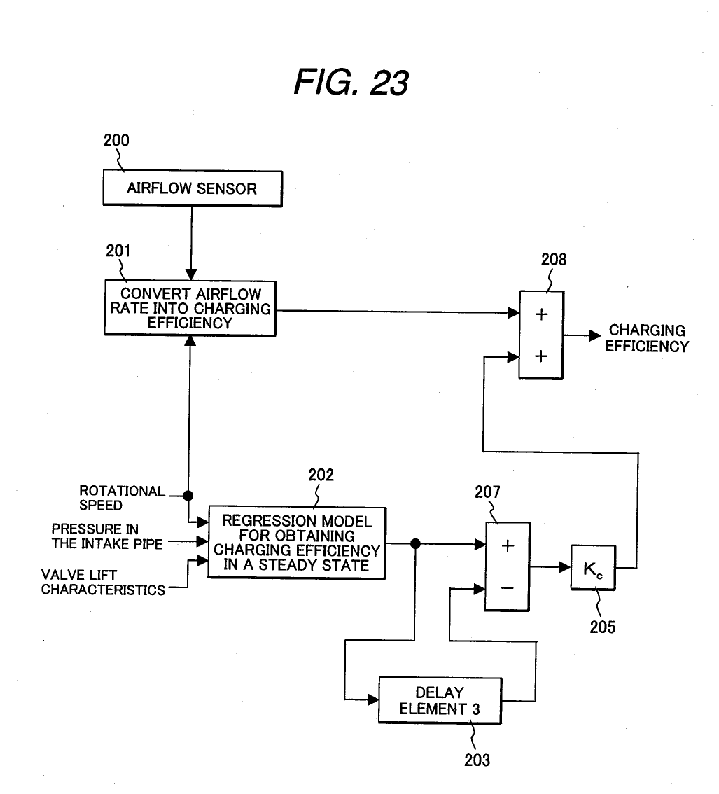

Control logic as illustrated in FIG. 23 may be used instead of the method in FIG. 22. The control blocks in FIG. 23 calculate the amount of air to be inhaled into the cylinder in an engine system that uses a different method in which a throttle valve is not used to reduce the amount of air to be inhaled.

In the method illustrated in FIG. 23, a difference between a change in charging efficiency, in the steady state, which is caused by a change in the valve lift characteristics during variable valve control and a value obtained by applying delay processing to the charging efficiency change is added to the output value from the airflow sensor.

In this method as well, the transient behavior of the charging efficiency, described with reference to FIG. 22, can also be calculated with high accuracy.

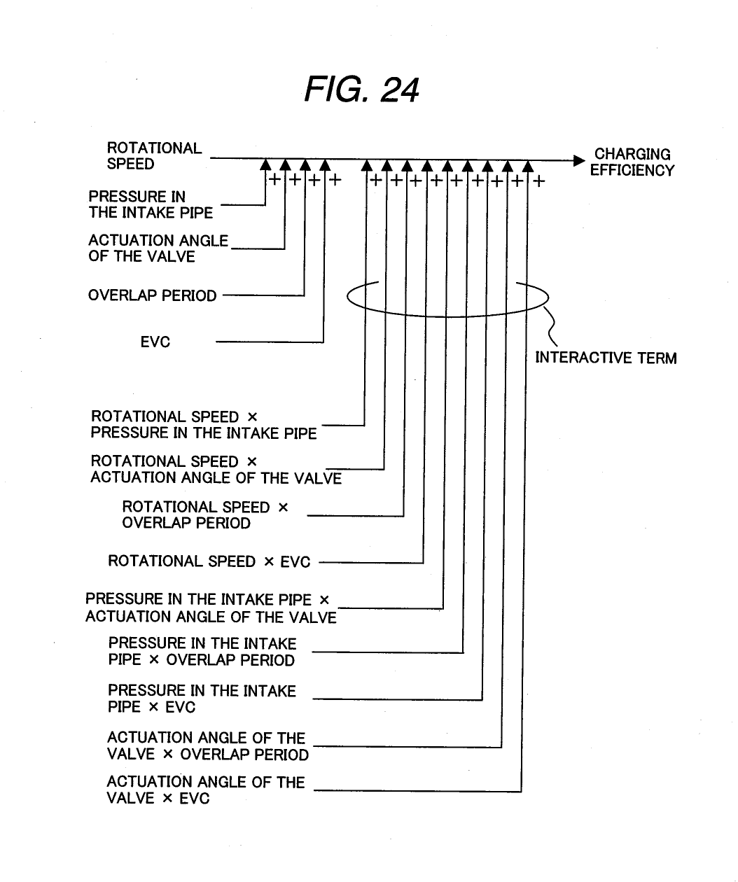

FIG. 24 illustrates a regression model that obtains the charging efficiency in the steady state of an internal combustion engine that uses the variable valve to perform load control.

In this embodiment, a polynomial regression model is used to calculate the charging efficiency in the steady state, in consideration of the effect of the rotational speed, the pressure in the intake pipe, the actuation angle of the intake valve or valve lift, the overlap period, and EVC, which are given to the charging efficiency.

Terms up to a quartic term are considered by using these effect factors as explanatory variables. To represent interactive terms among the above effect factors as part of the model, interactive terms are provided up to the quartic term.

When high-order terms and interactive terms are included in the regression model in this way, the engine charging efficiency, which is non-linear, can be efficiently approximated.

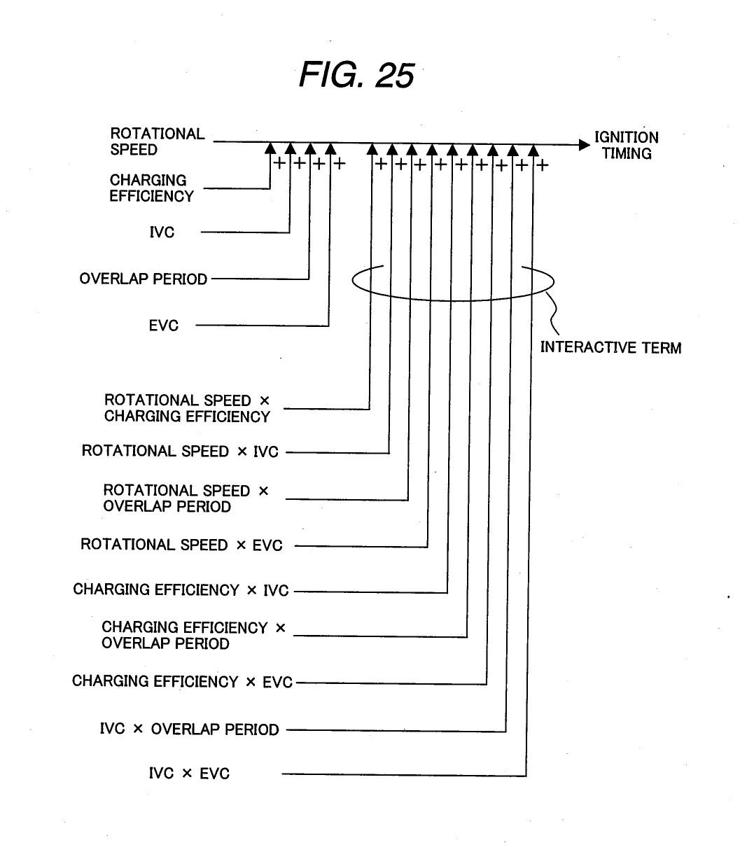

FIG. 25 illustrates a regression model that obtains ignition timing in an internal combustion engine in which the variable valve is used for load control.

To accurately obtain the ignition timing, at least the rotational speed, charging efficiency, IVC (closing angle of the intake valve), overlap period, and EVC are used as input variables supplied to the regression model. High-order terms and interactive terms are set for the variables so that the regression model is optimized by a likelihood ratio test as in the charging efficiency regression model.

In an engine system in which an intake valve is equipped with a variable valve that continuously changes the actuation angle and phase of the intake valve as shown in FIG. 2, the actual piston compression ratio largely changes depending on the IVC, so a knock behavior, which is an important factor in ignition timing control, must be appropriately represented. This is the reason why IVC is considered for the ignition timing regression model.

The reason why the overlap period and EVC are used as variables is that they are important factors to determine the internal EGR amount that is thought to largely affect the ignition timing. In this regression model, the atmospheric pressure may be added as a variable (not shown). When the effect of the atmospheric pressure is considered, the effect of the ignition timing that changes due to a reduction in the internal EGR at a high altitude can be accurately approximated.

A part related to ignition timing control as described above is referred to as a means for calculating an amount by which ignition timing is controlled according to an estimated charging efficiency of an internal combustion engine.

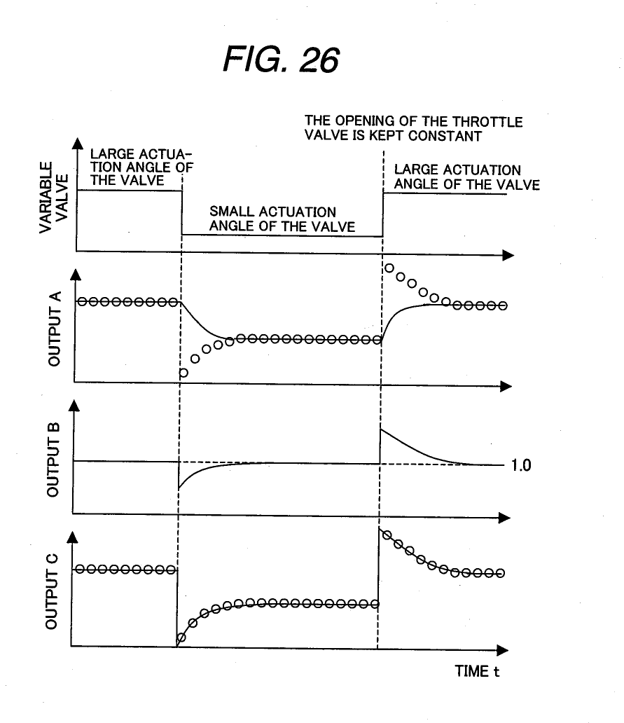

FIG. 26 illustrates how outputs from control blocks change with time, the control blocks calculating the charging efficiency when the actuation angle of the intake valve is increased and decreased by controlling the variable valve.

While the outputs from control blocks change with time, the pressure in the intake pipe is kept at atmospheric pressure or a pressure slightly lower than atmospheric pressure. The actuation angle of the intake valve is reduced like a rectangular waveform; the output value from the airflow sensor gradually decreases as indicated by output A.

The amount of air actually inhaled into the cylinder decreases with an overshoot, after which it converges to a steady state.

As described above, when the state of the variable valve changes rapidly, the output value of the airflow sensor involves a delay with respect to the amount of air actually inhaled into the cylinder. This delay also occurs even when the actuation angle of the intake valve increased like a rectangular waveform.

Output B is obtained as a ratio between a charging efficiency change, in a steady state, which is caused by a change in the valve lift characteristics during variable valve control, and a value obtained by applying delay processing to the change. When output A is multiplied by the ratio in the block 206 as a compensation value, the amount of air actually inhaled into the cylinder is calculated.

After the processing described above has been performed, the charging efficiency is accurately calculated using the value detected by the airflow sensor as the input even when the state of the variable valve changes rapidly.

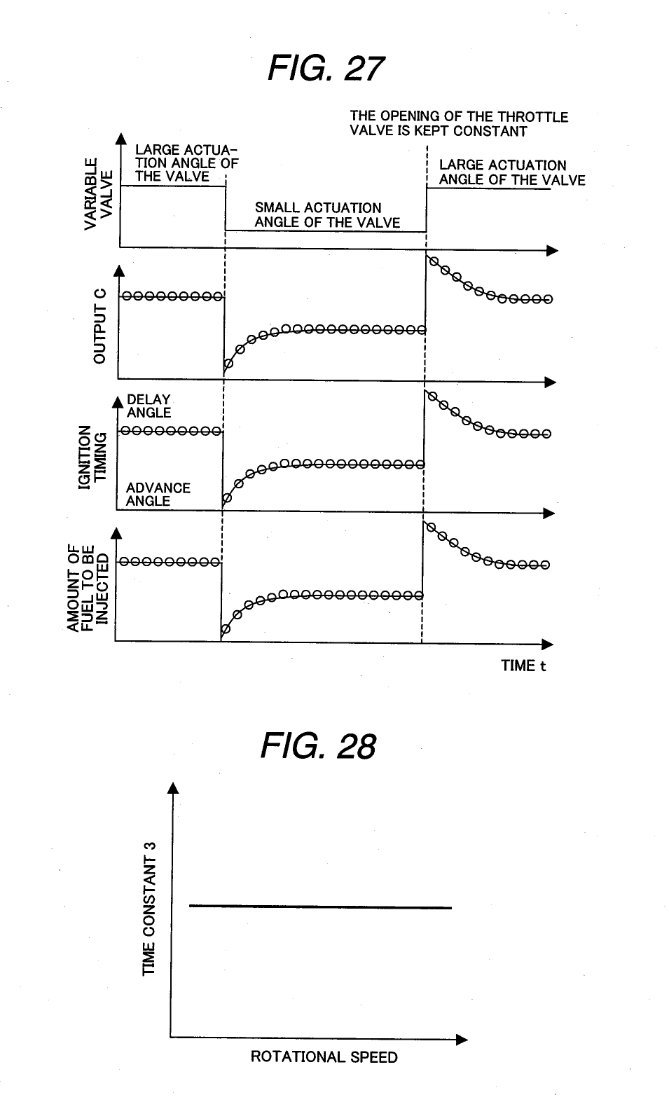

FIG. 27 illustrates output results for ignition timing and the amount of fuel to be injected when the actuation angle of the intake valve is increased or decreased by controlling the variable valve, in the control blocks that calculate the ignition timing and the amount of fuel to be injected.

Since the ignition timing and the amount of fuel to be injected are calculated according to the charging efficiency, they change according to a change in the cylinder charging efficiency during transition. When the actuation angle of the intake valve is changed rapidly, the cylinder charging efficiency decreases with an overshoot, after which it converges to a steady state.

The ignition timing is controlled at an advanced angle to cause an overshoot according to the charging efficiency change described above, after which it converges to a steady state. The amount of fuel to be injected also changes according to the overshoot of the charging efficiency.

In case of a rapid increase in the actuation angle of the intake valve as well, the ignition timing and the amount of fuel to be injected similarly change according to the overshoot of the charging efficiency.

As described above, even during transition of the variable valve, the ignition timing and the amount of fuel to be injected are appropriately controlled or calculated according to the output value of the airflow sensor, preventing the operation performance and exhaust performance from being worsened during transition.

FIG. 28 illustrates a relation to a time constant included in a primary element used in delay element 3.

In comparison under the same engine specifications, when a substantially fixed value is used as the time constant included in the primary delay element regardless of the rotational speed, the transient change of the charging efficiency can be accurately calculated. When this relation between the time constant and the rotational speed is used, the need to adapt the time constant for each rotational speed is eliminated, reducing an adaptation cost.

Main features of the embodiments of the present invention described above will be described below.

1. The present invention has a means for calculating a change in the charging efficiency in a steady state of an internal combustion engine by using a regression model based on the rotational speed of the internal combustion engine, the pressure in the intake valve, and a change in the state of the variable valve mechanism, and also includes a means for compensating for a delay in flow rate detection by the intake airflow rate detection means, according to the change in the charging efficiency.

Therefore, the charging efficiency can be accurately estimated without detection delay even during transition of the variable valve.

2. The present invention has a means for estimating the charging efficiency of an internal combustion engine by applying processing by a delay element to the charging efficiency change calculated by the regression model, obtaining a delay compensation amount from a ratio between the charging efficiency change before processing and another charging efficiency change after processing, and multiplying the flow rate detected by the intake airflow detection means by the delay compensation amount.

Accordingly, a delay element is processed on a charging efficiency change caused by a variable valve operation change, the charging efficiency change is calculated by the regression model, and the delay compensation amount is obtained from a ratio between the charging efficiency change before the delay element is processed and the charging efficiency change after the delay element has been processed. The flow rate detected by the intake airflow detection means is then multiplied by the delay compensation amount to estimate the charging efficiency of an internal combustion engine. Therefore, the charging efficiency estimation is accurate without a detection delay even during transition of a variable valve used by an internal combustion engine to control a load.

3. The present invention has a means for estimating the charging efficiency of an internal combustion engine by applying processing by a delay element to the charging efficiency change calculated by the regression model, obtaining a delay compensation amount from a ratio between the charging efficiency change before processing and another charging efficiency change after processing, and adding the delay compensation amount to the flow rate detected by the intake airflow rate detection means.

Accordingly, a delay element is processed on a charging efficiency change caused by a variable valve operation change, the charging efficiency change is calculated by the regression model, and the delay compensation amount is obtained from a difference between the charging efficiency change before the delay element is processed and the charging efficiency change after the delay element has been processed. The delay compensation amount is then added to the flow rate detected by the intake airflow detection means to estimate the charging efficiency of an internal combustion engine. Therefore, the charging efficiency estimation is accurate even during transition of a variable valve used by an internal combustion engine to control a load.

4. The present invention has a means for estimating the charging efficiency of an internal combustion engine by applying processing of a delay element to the charging efficiency change calculated by the regression model, obtaining a delay compensation amount from a ratio between the charging efficiency change before processing and another charging efficiency change after processing, applying processing of another delay element to the flow rate detected by the intake airflow rate detection means, and multiplying the flow rate to which the processing of the other delay element has been applied by the delay compensation amount.

Accordingly, a delay element is processed on a charging efficiency change caused by a variable valve operation change, the charging efficiency change is calculated by the regression model, and the delay compensation amount is obtained from a ratio between the charging efficiency change before the delay element is processed and the charging efficiency change after the delay element has been processed. Another delay element is processed on the flow rate detected by the intake airflow rate detection means, and the flow rate to which the processing by the other delay element has been applied is then multiplied by the delay compensation amount, so as to estimate the charging efficiency of an internal combustion engine. Therefore, the charging efficiency estimation is accurate even during transition of a variable valve in an internal combustion engine that uses a throttle valve to control a load and during transition of the throttle valve.

5. The present invention has a means for estimating the charging efficiency of an internal combustion engine by applying processing of a delay element to the charging efficiency change calculated by the regression model, obtaining a delay compensation amount from a difference between the charging efficiency change before processing and another charging efficiency change after processing, applying processing by another delay element to the flow rate detected by the intake airflow rate detection means, and adding the delay compensation amount to the flow rate to which the other processing of the delay element has been applied.

Accordingly, a delay element is processed on an charging efficiency change caused by a variable valve operation change, the charging efficiency change is calculated by the regression model, and the delay compensation amount is obtained from a difference between the charging efficiency change before the delay element is processed and the charging efficiency change after the delay element has been processed. Another delay element is processed on the flow rate detected by the intake airflow rate detection means, and a delay compensation amount is then added to the flow rate to which the processing by the other delay element has been applied, so as to estimate the charging efficiency of an internal combustion engine. Therefore, the charging efficiency estimation is accurate even during transition of a variable valve in an internal combustion engine that uses a throttle valve to control a load and during transition of the throttle valve.

6. The delay element is represented by a primary delay transmission function. The time constant included in the primary delay transmission function is given as a fixed value.

Since the delay element is represented by a primary delay transmission function and the time constant included in the primary delay transmission function is given as a fixed value, the amount of air to be inhaled into the cylinder can be accurately estimated even when the rotational speed of an internal combustion engine that uses a variable valve to perform load control varies. Man-hours required for time-constant adaptation can also be reduced.

7. The delay element is represented by a primary delay transmission function. The time constant included in the primary delay transmission function is given so that the time constant is at least inversely proportional to the rotational speed of an internal combustion engine.

Since the delay element is represented by a primary delay transmission function and the time constant included in the primary delay transmission function is given so that the time constant is at least inversely proportional to the rotational speed of an internal combustion engine, the amount of air to be inhaled into the cylinder can be accurately estimated even when the rotational speed of an internal combustion engine that uses a throttle valve to perform load control varies. Man-hours required for time-constant adaptation can also be reduced.

8. The regression model includes a term for the rotational speed, a term for the intake pipe pressure, a term for the valve lift characteristics, and an interactive term having at least two variables for the rotational speed, the intake pipe pressure, and the valve lift characteristics, the regression model being a polynomial having at least one of these terms.

Since the regression model is a polynomial that has a term only for the rotational speed, a term only for the intake pipe pressure, a term only for the valve lift characteristics, and an interactive term having at least two variables for the rotational speed, intake pipe pressure, and valve lift characteristics, the charging efficiency in the steady state can be accurately calculated with the effects of the rotational speed, intake pipe pressure, and valve lift characteristics taken into consideration.

9. The valve lift characteristics of the regression model is a term for the actuation angle of an intake valve, a term for the overlap period, a term for the timing to close the exhaust valve, and an interactive term having at least two variables for the actuation angle of the intake valve, the overlap period, and the timing to close the exhaust valve, and is represented by a polygonal having at least one of these terms.

Since the valve lift characteristics of the regression model is a term for the actuation angle of an intake valve, a term for the overlap period, a term for the timing to close the exhaust valve, and an interactive term having at least two variables for the actuation angle of the intake valve, the overlap period, and the timing to close the exhaust valve, and is represented by a polygonal having at least one of these terms, the charging efficiency in the steady state can be accurately calculated with the effects of the actuation angle on the intake valve, the overlap period, and the timing to close the exhaust valve taken into consideration.

10. A means for detecting or estimating the atmospheric pressure or the pressure in the exhaust pipe is provided, and a means for correcting the charging efficiency by using an interactive term for the overlap period and a difference between the atmospheric pressure or the pressure in the exhaust pipe and the pressure in the intake pipe is also provided, the difference being used as a variable.

Since the means for detecting or estimating the atmospheric pressure or the pressure in the exhaust pipe is provided, and a means for correcting the charging efficiency by using an interactive term for the overlap period and a difference between the atmospheric pressure or the pressure in the exhaust pipe and the pressure in the intake pipe is also provided, the difference being used as a variable, the charging efficiency in the steady state can be accurately calculated even at a high altitude.

11. A means for calculating the amount of fuel to be injected according to the estimated charging efficiency of an internal combustion engine and a target air-fuel ratio is provided.

Since the means for calculating the amount of fuel to be injected according to the estimated charging efficiency of an internal combustion engine and the target air-fuel ratio is provided, the amount of fuel to be injected can be appropriately controlled even during transition of the variable valve and throttle valve, alleviating problems that operability and exhaust performance are reduced.

12. A means for calculating an amount by which ignition timing is controlled according to at least the estimated charging efficiency of an internal combustion engine is provided.

Since the means for calculating an amount by which ignition timing is controlled according to at least the estimated charging efficiency of an internal combustion engine is provided, the ignition timing can be accurately controlled.

13. The means for calculating an amount by which ignition timing is controlled has a regression model based on at least the rotational speed of an internal combustion engine, the estimated charging efficiency of an internal combustion engine, and the valve lift characteristics of the variable valve.

Since the means for calculating an amount by which ignition timing is controlled has a regression model based on at least the rotational speed of an internal combustion engine, the estimated charging efficiency of an internal combustion engine, and the valve lift characteristics of the variable valve, the ignition timing can be accurately controlled with the effects of the rotational speed, intake pipe pressure, and valve lift characteristics taken into consideration.

14. The regression model includes a term for the rotational speed, a term for the charging efficiency, a term for the valve lift characteristics, and an interactive term having at least two variables for the rotational speed, the charging efficiency, and the valve lift characteristics, the regression model being a polynomial having at least one of these terms.

Since the regression model for obtaining the ignition timing is a polynomial that has a term only for the rotational speed, a term only for the amount of air to be inhaled into the cylinder, a term only for the valve lift characteristics, and an interactive term having at least two variables for the rotational speed, the amount of air to be inhaled into the cylinder, and the valve lift characteristics, the ignition timing can be accurately calculated with the effects of the rotational speed, charging efficiency, and valve lift characteristics taken into consideration.

15. The valve lift characteristics of the regression model is a term for the timing to close the intake valve, a term for the overlap period, a term for the timing to close the exhaust valve, and an interactive term having at least two variables for the timing to close the intake valve, the overlap period, and the timing to close the exhaust valve, and is represented by a polynomial including at least one of these terms.

Since the valve lift characteristics of the regression model is a term only for the timing to close the intake valve, a term only for the overlap period, a term only for the timing to close the exhaust valve, and an interactive term having at least two variables for the timing to close the intake valve, the overlap period, and the timing to close the exhaust valve, and is represented by a polynomial including at least one of these terms, the ignition timing can be accurately calculated.

What is claimed is:

1. A controller for an internal combustion engine that has a variable valve mechanism for changing at least one of a valve timing of an intake valve and/or an exhaust valve and valve lift characteristics according to an operation state of the internal combustion engine and also includes an intake air flow rate detection means for detecting an air flow rate in an intake pipe in the internal combustion engine, the controller comprising:
a means for calculating a change in a charging efficiency in a steady state of the internal combustion engine by using a regression model based on a rotational speed of the internal combustion engine, a pressure in the intake pipe, and a change in the state of the variable valve mechanism; and
a means for estimating the charging efficiency of the internal combustion engine by compensating for a delay in flow rate detection by the intake air flow rate detection means according to the change in the charging efficiency calculated by the regression model.

2. The controller according to claim 1, wherein the means for estimating the charging efficiency of the internal combustion engine applies processing by a delay element to the change in the charging efficiency change calculated by the regression model, obtains a delay compensation amount from a ratio between the change in the charging efficiency before the processing and another change in the charging efficiency after the processing, and multiplies the flow rate detected by the intake air flow rate detection means by the delay compensation amount.

3. The controller according to claim 1, wherein the means for estimating the charging efficiency of the internal combustion engine applies processing by a delay element to the change in the charging efficiency calculated by the regression model, obtains a delay compensation amount from a ratio between the change in the charging efficiency before the processing and another change in the charging efficiency after the processing, and adds the delay compensation amount to the flow rate detected by the intake air flow rate detection means.

4. The controller according to claim 1, wherein the means for estimating the charging efficiency of the internal combustion engine applies processing by a delay element to the change in the charging efficiency calculated by the regression model, obtains a delay compensation amount from a ratio between the change in the charging efficiency before the processing and another change in the charging efficiency after the processing, applies processing by another delay element to the flow rate detected by the intake air flow rate detection means, and multiplies the flow rate to which the processing by the another delay element has been applied by the delay compensation amount.

5. The controller according to claim 1, wherein the means for estimating the charging efficiency of the internal combustion engine applies processing by a delay element to the change in the charging efficiency calculated by the regression model, obtains a delay compensation amount from a difference between the change in the charging efficiency before the processing and another change in the charging efficiency after the processing, obtains a delay compensation amount from a ratio between the change in the charging efficiency before the processing and another change in the charging efficiency after the processing, and adds the delay compensation amount to the flow rate detected by the intake air flow rate detection means, applies processing by another delay element to the flow rate detected by the intake air flow rate detection means, and adds the delay compensation amount to the flow rate to which the processing by the another delay element has been applied.

6. The controller according to claim 2, wherein:
the delay element is represented by a primary delay transmission function; and
the time constant included in the primary delay transmission function is given as a fixed value.

7. The controller according to claim 4, wherein:
the delay element is represented by a primary delay transmission function; and
the time constant included in the primary delay transmission function is given so that the time constant is at least inversely proportional to the rotational speed of the internal combustion engine.

8. The controller according to claim 1, wherein the regression model includes a term for the rotational speed, a term for the pressure in the intake pipe, a term for the valve lift characteristics, and an interactive term having at least two variables of the rotational speed, the pressure in the intake pipe pressure, and the valve lift characteristics, the regression model being a polynomial having at least one of these terms.

9. The controller according to claim 8, wherein the valve lift characteristics of the regression model is a term for an actuation angle of the intake valve, a term for an overlap period, a term for a timing to close the exhaust valve, and an interactive term having at least two variables of the actuation angle of the intake valve, the overlap period, and the timing to close the exhaust valve, and is represented by a polygonal having at least one of these terms.

10. The controller according to claim 9, further comprising:
a means for detecting or estimating an atmospheric pressure or a pressure in the exhaust pipe; and
a means for correcting the charging efficiency by using an interactive term for the overlap period and a difference between the atmospheric pressure or the pressure in the exhaust pipe and the pressure in the intake pipe, the difference being used as a variable.

11. The controller according to claim 1, further comprising a means for calculating an amount of fuel to be injected according to the estimated charging efficiency of the internal combustion engine and a target air-fuel ratio.

12. The controller according to claim 1, further comprising a means for calculating an amount by which an ignition timing is controlled according to at least the estimated charging efficiency of the internal combustion engine.

13. The controller according to claim 12, wherein the means for calculating an amount by which an ignition timing is controlled has a regression model based on at least the rotational speed of the internal combustion engine, the estimated charging efficiency of the internal combustion engine, and the valve lift characteristics of the variable valve.

14. The controller according to claim 13, wherein the regression model includes a term for the rotational speed, a term for the charging efficiency, a term for the valve lift characteristics, and an interactive term having at least two variables of the rotational speed, the charging efficiency, and the valve lift characteristics, the regression model being a polynomial having at least one of these terms.

15. The controller according to claim 14, wherein the valve lift characteristics of the regression model is a term for a timing to close the intake valve, a term for the overlap period, a term for a timing to close the exhaust valve, and an interactive term having at least two variables of the timing to close the intake valve, the overlap period, and the timing to close the exhaust valve, and is represented by a polynomial including at least one of these terms.
